(19) United States
(12) Patent Application Publication
(10) Pub. No.: US 2009/0056090 A1
(43) Pub. Date: Mar. 5, 2009

(54) MEMORIAL ARTICLE AND METHOD THEREOF

(76) Inventors: Thomas Bunk, West Middlesex, PA (US); Mark Grasso, West Middlesex, PA (US)

Correspondence Address: Fay Sharpe LLP, 1228 Euclid Avenue, 5th Floor, The Halle Building, Cleveland, OH, 44115-1843, US

(21) Appl. No.: 12/205,218

(22) Filed: Sep. 5, 2008

Related U.S. Application Data
(60) Provisional application No. 60/967,501, filed on Sep. 5, 2007.

(51) Int. Cl. A61G 17/00; A61G 17/08

(52) U.S. Cl. 27/1; 40/124.5; 29/428

(57) ABSTRACT

The present invention provides a memorial article selected from the group consisting of a cremation urn, a rosette, a vase ring, a plaque, a pedestal, and any combination thereof. The memorial articles are made from titanium or a titanium alloy, and anodized to a desirable color. The memorial article exhibits improved corrosion resistance and mechanical stability; and can be widely used in the funeral and death care industry.

### BACKGROUND OF THE INVENTION

The present invention is related to a memorial article selected from the group consisting of a cremation urn, a rosette, a vase ring, a plaque, a pedestal, and any combination thereof. The article can be used in association with holding and displaying cremated remains of a loved one in the funeral and death care industry.

A memorial article such as an urn allows survivors to honor their deceased loved ones, preserve a family's heritage, and create a bond between generations. With its origin dating back to the early Stone Age in roughly 3000 B.C., the practice of cremation migrated throughout cultures over the world. Early Christian and Jewish cultures rejected cremation in favor of earth burial by about 400 A.D. Over the next 1500 years, earth burial dominated the method survivors chose to remember the deceased. However, because of increased concern for health conditions around cemeteries and the ever-increasing costs of earth burials, cremation was revived in the latter half of the 19^{th} century, and regained popularity in both North America and Europe as an alternative for the memorialization of the deceased.

Known prior arts related to memorial articles such as urn products include U.S. Pat. No. 5,875,528; U.S. Pat. No. Des. 266,619; U.S. Pat. No. Des. 356,422; U.S. Pat. No. Des. 385,081; U.S. Pat. No. Des. 345,848; and U.S. Pat. No. Des. 266,620. Memorial articles may be placed in indoor, outdoor, and semi-outdoor environments. For example, an urn may be placed in a columbarium niche which provides a recessed portion in a wall designed to contain the urn. Memorial parks offer designated space for the internment of cremated remains. Most cemeteries and mausoleums provide patrons the option of space specifically designed for the internment of cremated remains. Many cemeteries will also allow cremated remains to be memorialized in pre-purchased family plots. Others opt to remember their loved one by displaying a memorial containing cremated ashes in their homes.

Memorial articles such urns can be manufactured from steel, stainless steel, brass, bronze, copper, stone, turned-stone, ceramic material, paper, wood, plastics, and glass etc. However, metallic articles such as urns, particularly those in outdoor and semi-outdoor environments, are prone to be corroded, degraded and discolored, due to sunshine exposure, moisture, extreme temperature and pH, atmospheric chemicals, contaminated rainfall, biological organisms and their excretions, as well as other environmental factors. Moreover, memorial articles such as urns made of stainless steel have a cracking problem over a long time of usage. All these undesirably affect the life term and the aesthetic look of the memorial articles. As such, there exists a need to provide a memorial article that can overcome or alleviate the above problems.

Advantageously, the present invention provides a memorial article which is corrosion resistant, mechanically stable, aesthetical, dignified, and personal, among others.

### BRIEF DESCRIPTION OF THE INVENTION

One aspect of the invention is to provide a memorial article selected from the group consisting of a cremation urn, a rosette, a vase ring, a plaque, a pedestal, and any combination thereof, which is corrosion resistant, aesthetical, dignified, and personal.

Another aspect of the invention is to provide a method of making a memorial article selected from the group consisting of a cremation urn, a rosette, a vase ring, a plaque, a pedestal, and any combination thereof.

### BRIEF DESCRIPTION OF THE DRAWINGS

FIG. 1 is the front perspective view illustrating a cremation urn in accordance with an embodiment of the invention;

FIG. 2 is a plaque design in accordance with an embodiment of the invention;

FIG. 3 is the front view of a rosette design in accordance with an embodiment of the invention;

FIG. 4 is the side view of a rosette design in accordance with an embodiment of the invention;

FIG. 5 is the rear view of a rosette design in accordance with an embodiment of the invention;

FIG. 6 is the front view of a vase ring design in accordance with an embodiment of the invention; and

FIG. 7 is the side view of a vase ring design in accordance with an embodiment of the invention.

### DETAILED DESCRIPTION OF THE INVENTION

The memorial article such as an urn according to the present invention is made from titanium or a titanium alloy, which is resistant to corrosion and mechanically stable. Titanium is very stable over a wide range of pH and temperatures. Also, the cracking problem that occurs with stainless steel is near non-existent with most commercial grade titanium and its alloys.

Unalloyed titanium is virtually impervious to crevice corrosion up to 185° F. in organic type environments. By introducing molybdenum, palladium, and/or ruthenium to the titanium, the corrosion resistance is significantly increased beyond 185° F. Aluminum, vanadium, and other beta alloying elements can be added in order to make an alloy obtain higher mechanical properties. Examples of metal that can be used with titanium to form various alloys include, but are not limited to, aluminum (Al), chromium (Cr), cobalt (Co), iron (Fe), manganese (Mg), molybdenum (Mo), nickel (Ni), niobium (Nb), palladium (Pa), ruthenium (Ru), silicon (Si), tantalum (Ta), tin (Sn), vanadium (V), yttrium (Y), zirconium (Zr), and the combination thereof. Specific examples of titanium and alloys thereof include Alpha Alloys such as ASTM Grade 12, 5AL-2.5SN, 5AL-2.5SN-(ELI), 5AL-5ZR-5SN, 8AL-1 MO-1V; Beta Alloys such as 3AL-8V-6CR-4MO-4Z, 15V-3AL-3CR-3SN, Timet's Alloy sold under the trademark BETA 21-S, LCB, 13V-11 CR-3AL; Alpha-Beta Alloys such as 3AL-2.5V, 10V-2FE-3AL, 6AL-2SN-4ZR-2MO, 6AL-4V, 6AL-4V-(ELI), 6AL-6V2SN, 6AL-2SN-2ZR-2MO-2CR, 6AL-2SN-4ZR-6MO, 6AL-7NB, 7AL-4MO, 8MN; and commercially pure Grades such as commercially pure ASTM Grade 1, Grade 2, Grade 3, Grade 4, Grade 7, Grade 13, Grade 14, Grade 15, Grade 16, Grade 17 and Grade 18.

Without being limited by any particular theory, it is believed that, when exposed to oxygen, titanium is very reactive and tends to form a thin film of titanium oxide. This film renders titanium the strong resistance to corrosion. The layer of oxide even has the ability to “heal” itself after it has been scratched, because after the metal has been scratched, a new layer of oxide will quickly form.

In preferred embodiments, the material is Commercially Pure Titanium or Titanium Grade 2.

In various embodiments of the invention, the titanium article such as an urn is anodized to a desirable color, such as gold, bronze, silver, brown or dark bronze, brown oxide, light green, medium green, light blue, medium blue, aqua, fuchsia, pink, violet, and gray.

In exemplary embodiments, the anodizing can be performed by three methods. One method is passing a current through an electrode, using different aqueous solutions comprising of acids, bases or salts. The second can be anodized by a plasma anodizing technique. The third can be anodizing titanium in a fused-salt bath such as molten nitrate electrolytes.

The urns of the invention can have a wide variety of designs and styles, such as cubes, jars, vases, sculptures, bookends, mausoleums, and garden implements.

In exemplary embodiments, the rosettes are used in Columbarium or Mausoleums. A columbarium is a building in a cemetery or memorial park that houses urns. The columbarium usually has multiple compartments. The face (or entrance) to these compartments are attached (& sealed) by Rosettes. Mausoleums are a building in a cemetery or memorial park that houses a casket. The columbarium usually has multiple compartments. The face (or entrance) to these compartments are attached (& sealed) by Rosettes. The vase ring is a ring and stem that is attached to the face (or entrance) of columbarium compartment or mausoleum compartment that holds the final remains. The vase rings give the option of adding flowers. Each compartment of a columbarium or mausoleum may have plaque to identify the remains.

The following description should be read with reference to the drawings, in which like elements in different drawings are numbered in like fashion. The drawings, which are not necessarily to scale, depict selected embodiments and are not intended to limit the scope of the invention. Although examples of construction, dimensions, and materials are illustrated for the various elements, those skilled in the art will recognize that many of the examples provided have suitable alternatives that may be utilized.

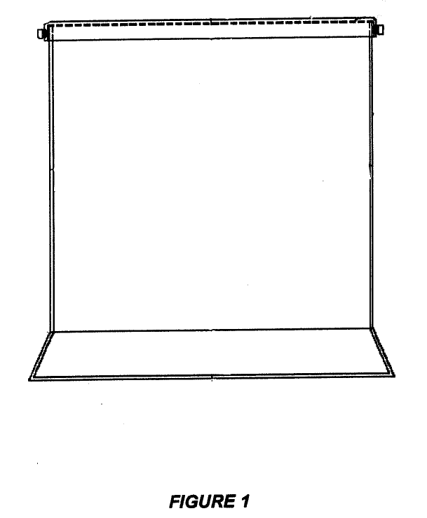

FIG. 1 is a front perspective view illustrating a cremation urn in accordance with an exemplary embodiment of the present invention. With reference to FIG. 1, titanium urn body 1, consisting of a main body and a base portion with a sloped wall, is configured to receive and store cremated remains. The main body has a diameter of A, and the height of the urn is B. The bottom diameter of the base is C, and the height of the base is D. Two titanium set screws, one of which is set crew 2, secure titanium cover 4 with urn body 1. Rubber gasket 3 is placed between urn cover 4 and urn body 1 for sealing.

In an embodiment, the urn illustrated in FIG. 1 can have a volume of 145 cube inches, with that the values of A, B, C, and D are, for example, 6.63 inches, 7.38 inches, 7.50 inches, and 1.00 inch respectively.

In another embodiment, the urn illustrated in FIG. 1 can have a volume of 215 cube inches, with that the values of A, B, C, and D are, for example, 7.63 inches, 9.38 inches, 8.50 inches, and 1.50 inches respectively.

In yet another embodiment, the urn illustrated in FIG. 1 can have a volume of 285 cube inches, with that the values of A, B, C, and D are, for example, 9.00 inches, 10.38 inches, 9.88 inches, and 1.63 inches respectively.

The pedestal may be used to support the urn, so that, for example, the urn is in a display mode. In preferred embodiments, the pedestal is also made from titanium or a titanium alloy, and anodized to any desirable color, as described above.

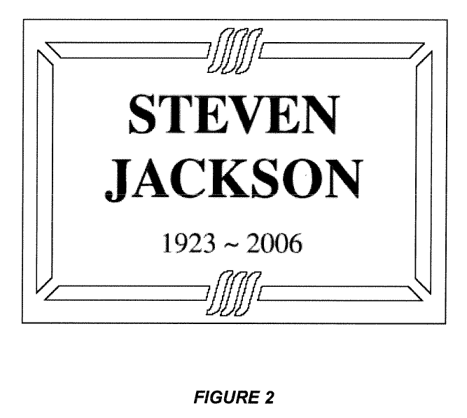

The plaque may be used as a visual indicia or an inscription plate capable of being personalized or customized with, for example, pictures, scenes, designs, identification information, script or other written information. Optionally, the plaque may have a picture frame that provides a display window capable of displaying an image, a portrait or a picture. FIG. 2 shows a plaque design with words such as “STEVEN JACKSON 1923-2006”, which is only illustrative of the identification, stylistic, or ornamental feature that may be displayed.

In preferred embodiments, the plaque is also made from titanium or a titanium alloy, and anodized to any desirable color, as described above. The text and image on the plaque may be applied using any known method such as etching, laser etching, chemical etching, machining, milling, chemical milling, cold or hot working blasting processes such as peening, and/or blasting. In a preferred embodiment, the text and image are etched on the plaque with hydrofluoric acid or nitric acid.

In an embodiment, the plaque is physically fastened with the urn. Alternatively, the text and image that are intended to be applied on the plaque may be directly applied on the urn surface by etching with hydrofluoric acid or nitric acid.

The rosette can also be made from titanium or a titanium alloy, and anodized to any desirable color, as described above. The rosette design can be produced using any known method such as etching, laser etching, chemical etching, machining, milling, chemical milling, cold or hot working blasting processes such as peening, and/or blasting. In a preferred embodiment, the rosette design is etched with hydrofluoric acid or nitric acid. The method of choice for the Rosettes is forging or castings. Dimensions and cosmetic designs may vary depending on the construction style of the columbarium or mausoleum.

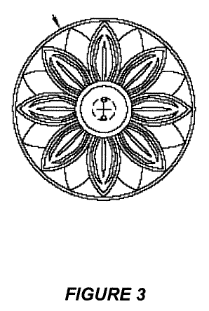

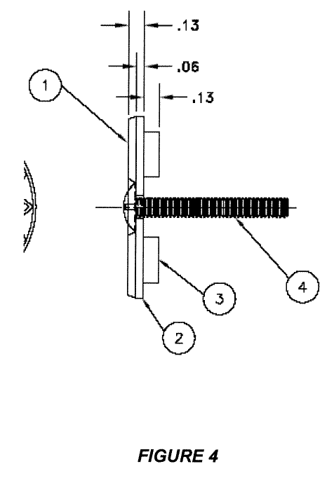

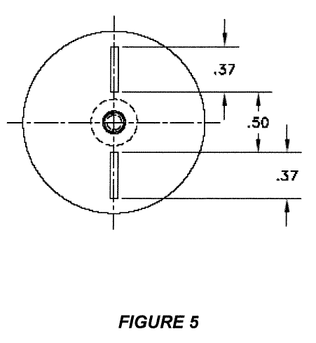

FIG. 3 illustrates the front view of a rosette design that can be hung from a generally vertical wall. The diameter of rosette may be, for example, 1.50 inches. In the canter of FIG. 3 rosette is a hole for a fasten means such as a drilled spanner bolt with a truss head. FIG. 4 is the side view of the rosette in FIG. 3. A design plate 1 is fastened with a back plate 2 using a drilled spanner bolt 4. Two lock bars 3 can be applied on the back plate 2. There is no specific limitation to the dimension of the rosette. In exemplary embodiments, design plate 1 has a dimension of Ø1.50×0.06″ thick; back plate 2 has a dimension of Ø1.50×0.06″ thick; two lock bars 3 can have a dimension of 0.06×0.13×0.37 (inch) and a distance of 0.5 inch between each other; and drilled spanner bolt 4 can have a dimension of 10-14×1.25″ length with a truss head. FIG. 5 is the rear view of the rosette in FIG. 3, in which the length of the lock bars A can be for example 0.37 inch; the distance between the two bars B can be for example 0.50 inch.

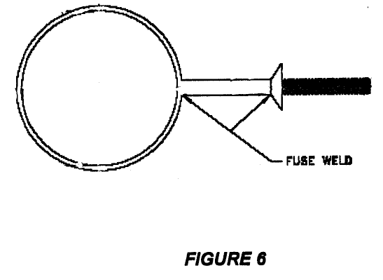

The vase ring can also be made from titanium or a titanium alloy, and anodized to any desirable color, as described above. FIG. 6 illustrates the front view of a vase ring that can be attached on a wall. Vase ring 1 can be fuse weld with ring post 2 at one end of the post; and stop 3 with a thread (e.g. ¼-20) can be fuse weld with ring post 2 at another end of the post. There is no specific limitation to the dimension of the vase ring. As shown in FIG. 6, the internal diameter of vase ring 1 is A; the distance between the stop 3 and the central point of vase ring 3 is B; the length of the thread extended from stop 3 is C; and the thickness of the vase ring is D. In various embodiments, C can have a value of, for example, 1.44 inches; and D can have a value of, for example, 0.078 inch. The dimensional values of A and B are shown in the following table:

| A | B |
|---|---|
| (IN.) | (IN.) |
| 1.00 | 1.50 |
| 1.13 | 1.63 |
| 1.25 | 1.75 |
| 1.38 | 1.88 |
| 1.50 | 2.00 |
| 1.63 | 2.13 |
| 1.75 | 2.25 |
| 1.88 | 2.38 |
| 2.00 | 2.50 |
| 2.13 | 2.63 |
| 2.25 | 2.75 |
| 2.38 | 2.88 |
| 2.50 | 3.00 |
| 2.63 | 3.13 |
| 2.75 | 3.25 |
| 2.88 | 3.38 |
| 3.00 | 3.50 |
| 3.13 | 3.63 |
| 3.25 | 3.75 |
| 3.38 | 3.88 |
| 3.50 | 4.00 |
| 3.63 | 4.13 |
| 3.75 | 4.25 |
| 3.88 | 4.38 |
| 4.00 | 4.50 |
| 4.13 | 4.63 |
| 4.25 | 4.75 |

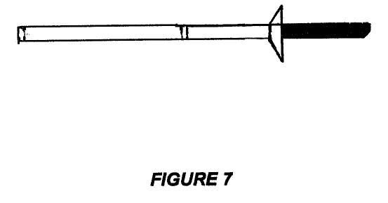

FIG. 7 illustrates the side view of the vase ring of FIG. 6. In an embodiment, the diameter or the “thickness”, A, of the vase ring 1 and ring post 2 can be for example 0.25 inch; the thickness B of stop 3 can be for example 0.19 inch; the diameter C of the stop can be for example 0.75 inch; and the open angle D of stop 3 can be for example 111° REF.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A corrosion resistant memorial article comprised of an alloy including:
titanium;
a first metal selected from molybdenum, palladium, and ruthenium;
a second metal selected from aluminum, chromium, cobalt, iron, manganese, molybdenum, nickel, niobium, palladium, ruthenium, silicon, tantalum, tin, vanadium, yttrium, zirconium, beta alloys and combinations thereof, and
wherein said article is anodized.

2. The memorial article according to claim 1, wherein said article is selected from a group consisting of a cremation urn, a rosette, a vase ring, a plaque, and a pedestal.

3. A corrosion resistant, anodized cremation urn comprised of an alloy, said urn including:
a body comprising a main body portion and a base portion with a sloped wall;
a cover;
at least two screws adapted to secure said cover to said body; and
at least one rubber gasket between said cover and said body.

4. A method for manufacturing a corrosion resistant memorial article comprised of an alloy, said method comprising:
providing titanium;
adding a first metal selected from molybdenum, palladium, and ruthenium;
adding a second metal selected from aluminum, chromium, cobalt, iron, manganese, molybdenum, nickel, niobium, palladium, ruthenium, silicon, tantalum, tin, vanadium, yttrium, zirconium, beta alloys and combinations thereof, and
anodizing said article.

5. The method of claim 4, wherein said article is selected from a group consisting of a cremation urn, a rosette, a vase ring, a plaque, and a pedestal.

6. The method of claim 5, wherein said plaque is customized with one or more pictures, scenes, designs, identification information, script and other written information.

7. The method of claim 6, wherein said customization is performed by etching, laser etching, chemical etching, machining, milling, chemical milling, or cold or hot working blasting processes.

8. The method of claim 4, wherein said anodizing is performed by passing a current through an electrode.

9. The method of claim 4, wherein said anodizing is performed by exposing said article to a plasma.

10. The method of claim 4, wherein said anodizing is performed by exposing said article to a fused-salt bath.
